(19) United States
(12) Patent Application Publication
(10) Pub. No.: US 2026/0175289 A1
(43) Pub. Date: Jun. 25, 2026

(54) METHOD OF CASTING METAL PARTS SUCH AS VALVE SEAT INSERT CASTING BLANKS AND CASTING APPARATUS

(71) Applicant: L.E. Jones Company, Menominee, MI (US)

(72) Inventors: Cong Yue Qiao, Menominee, MI (US); David M. Doll, Fort Worth, TX (US); Dominic S. Grillo, Menominee, MI (US); Steve J. Schmitz, Peshtigo, WI (US); Levi T. Kempka, Marinette, WI (US)

(73) Assignee: L.E. Jones Company, Menominee, MI (US)

(21) Appl. No.: 18/991,990

(22) Filed: Dec. 23, 2024

(51) Int. Cl. B22C 9/20; B22C 9/02; B22C 9/06; B22C 9/08; B33Y 80/00

(52) U.S. Cl. CPC B22C 9/20; B22C 9/082; B22C 9/02; B22C 9/067; B33Y 80/00

(57) ABSTRACT

A method of casting metal parts in a casting apparatus by pouring molten metal into a gating system of a mold plate stack having mold cavities wherein mold plates are located between a cover mold and a bottom mold. The gating system includes a casting header, down-sprue passing though the mold plates, at least one distribution runner in fluid communication with the down-sprue, at least one up-sprue in the mold plates, and at least one circumferential gate in each mold plate. The circumferential gate allows molten metal to flow into the bottom of the mold cavity, rise in the mold cavity and in the up-sprue at substantially the same velocity and at substantially the same height until the molten metal fills the mold cavity, then into the up-sprue of an overlying mold plate. After all of the mold cavities are filled with the molten metal, the molten metal solidifies to form cast metal parts interconnected by solidified metal in the down-sprue, the distribution runner, the up-sprue, and the circumferential gates.

### FIELD OF THE INVENTION

The present disclosure relates to a method of casting metal parts such as valve seat insert casting blanks which can be made of corrosion and wear-resistant alloys with high hardenability and sound elevated temperature applicability.

### BACKGROUND INFORMATION

In conventional casting systems, liquid metal is directed through a vertical sprue, horizontal distribution sprue, runner, and gate into a casting cavity. In manufacturing valve seat inserts (VSIs), such a system can be used with sand molds. In some VSI casting processes, shrinkage and hot tear susceptibility can be a problem even with riser type gating systems.

There is a need for improved VSI casting systems which minimize shrinkage and hot tear susceptibility of the cast VSIs.

### SUMMARY

In an embodiment, a method of casting metal parts, comprises pouring molten metal into a gating system of a mold plate stack having mold cavities wherein mold plates are located between a cover mold and a bottom mold, the gating system including a casting header, down-sprue passing though the mold plates, at least one distribution runner in fluid communication with the down-sprue, at least one up-sprue in the mold plates, and at least one circumferential gate in each mold plate with the circumferential gate in fluid communication with a lower portion of a single mold cavity configured to form a metal part, the gating system optionally including at least one gas release passage in fluid communication with the up-sprue and the mold cavity. The method includes filling the mold cavities with the molten metal such that molten metal passes into the down-sprue, the distribution runner and into the up-sprue in a lowermost mold plate, then through the circumferential gate and into the mold cavity, rises in the mold cavity and in the up-sprue at substantially the same velocity and at substantially the same height until the molten metal fills the mold cavity, then into the up-sprue of an overlying mold plate and repeats the mold cavity filling process of the lowermost mold plate until all of the mold cavities are filled with the molten metal. The molten metal then solidifies to form cast metal parts interconnected by solidified metal in the down-sprue, the distribution runner, the up-sprue, and the circumferential gates.

In an embodiment, at least one of the mold plates is a 3D printed sand composition having a gas release passage, the method including release of gas from the mold cavity via the gas release passage into an open portion of the up-sprue during filling of the mold cavity with molten metal.

In an embodiment, each of the mold plates has a plurality of up-sprues and mold cavities, the bottom mold has a plurality of distribution runners in fluid communication with the down-sprue and the up-sprues, and the mold stack includes gas release passages, the method including release of gas from the mold cavities via the gas release passages into open portions of the up-sprues during filling of the mold cavities with molten metal, thereby enhancing laminar molten metal flow and minimizing turbulence of molten metal during filling of the mold cavities.

In an embodiment, the mold cavity is ring-shaped and the circumferential gate is formed by spaced apart inner and outer conical walls which form a divergent annular flow path, the method including filling the divergent annular flow path with molten metal such that the molten metal flows evenly into the bottom of the ring-shaped mold cavity.

In an embodiment, the ring-shaped mold cavity has a bottom wall, a top wall, a circumferential outer wall and a circumferential inner wall and the method includes flowing molten metal through the divergent annular flow path into a circumferential opening in the bottom wall or inner wall of the ring-shaped mold cavity.

In an embodiment, each of the mold plates is a circular sand mold plate having a central opening corresponding to the down-sprue extending vertically between upper and lower surfaces of the mold plate, at least two circumferentially spaced openings corresponding to up-sprues extending vertically between the upper and lower surfaces of the mold plate, at least two ring-shaped mold cavities surrounding the up-sprues, and at least two circumferential gates extending from the up-sprues to bottoms of the two ring-shaped mold cavities, the method including solidification of the molten metal in the ring-shaped mold cavities and forming a mold stack of parts comprising valve seat insert casting blanks.

In an embodiment, each of the mold plates is a circular sand mold plate having a central opening corresponding to the down-sprue extending vertically between upper and lower surfaces of the mold plate, at least four circumferentially spaced openings corresponding to the up-sprues extending vertically between the upper and lower surfaces of the mold plate, at least four ring-shaped mold cavities surrounding the up-sprues, and at least four circumferential gates connecting the up-sprues to the ring-shaped mold cavities, the method including solidification of the molten metal in the ring-shaped mold cavities and forming a mold stack of parts comprising valve seat insert casting blanks.

In an embodiment, each of the mold plates is a circular sand mold plate having a central opening corresponding to the down-sprue extending vertically between upper and lower surfaces of the mold plate, at least five circumferentially spaced openings corresponding to the up-sprues extending vertically between the upper and lower surfaces of the mold plate, at least five ring-shaped mold cavities surrounding the up-sprues, and at least five circumferential gates extending between the up-sprues and the ring-shaped cavities, the method including solidification of the molten metal in the ring-shaped mold cavities and forming a mold stack of parts comprising valve seat insert casting blanks.

In an embodiment, the molten metal is a wear and corrosion resistant iron-base alloy, nickel-base alloy, cobalt-base alloy, or intermetallic-base alloy, the method further comprising maintaining a substantially uniform temperature distribution of the molten metal in a vertical direction during solidification of the molten metal in the mold cavities.

In an embodiment, the cover mold includes a fluid passage extending from the upper end of the up-sprue to the down-sprue, the method further comprising solidifying the molten metal after the molten metal fills the fluid passage, the cover mold allowing escape of trapped air into the down-sprue and providing sufficient thermal insulation in a vertical direction to improve surface quality of the cast parts.

In an embodiment, a mold plate useful in a casting apparatus comprising a casting header, a cover mold, a bottom mold, and stack of mold plates having mold cavities, and a gating system, comprises a down-sprue opening extending between an upper surface and lower surface of the mold plate, an up-sprue opening extending between the upper surface and the lower surface of the mold plate, a mold cavity surrounding the up-sprue, and a circumferential gate connecting the up-sprue to a bottom of the mold cavity.

In an embodiment, the mold plate is a 3D printed sand composition.

In an embodiment, the mold plate has a plurality of up-sprue openings and mold cavities, each of the up-sprues connected to a respective one of the mold cavities by a circumferential gate.

In an embodiment, the circumferential gate comprises a divergent annular flow path defined by a space between inner and outer conical walls.

In an embodiment, the mold cavity is a ring-shaped mold cavity with a bottom wall, top wall, outer cylindrical wall and inner cylindrical wall, the divergent annular flow path having a smaller diameter inlet end in fluid communication with the up-sprue opening and a larger diameter outlet end in fluid communication with the ring-shaped mold cavity via a circumferential opening in the bottom wall or inner wall of the ring-shaped mold cavity.

In an embodiment, a gas release passage extends from an upper portion of the mold cavity to the up-sprue opening.

In an embodiment, the mold cavity is located entirely within the mold plate. Alternatively, the mold plate comprises an upper cope mold plate and lower drag mold plate with the mold cavity extending into a lower surface of the cope mold plate and the circumferential gate located in the drag mold plate or the mold plate includes a cylindrical recess having an outer cylindrical wall defining an outer wall of the mold cavity and a center plug located in the cylindrical recess with an outer cylindrical surface of the center plug forming an inner wall of the mold cavity, the center plug having a central opening aligned with the up-sprue and a conical bottom surface defining the circumferential gate.

In an embodiment, a casting apparatus comprises a casting header, a cover mold, a bottom mold, and the mold plate described above, wherein a gating system of the casting apparatus includes the casting header, the down-sprue passing though the mold plate, a distribution runner in the bottom mold in fluid communication with the down-sprue and the up-sprue in the mold plate, and the circumferential gate in fluid communication with the mold cavity.

In an embodiment, the mold plate is in a stack of identical or non-identical mold plates, each of the mold plates including a plurality of up-sprues, mold cavities and circumferential gates, the casting apparatus further including gas release passages between the mold cavities and the up-sprues so that air in the mold cavities can escape to the up-sprues during filling of the mold cavities with molten metal.

### BRIEF DESCRIPTION OF THE DRAWINGS

FIG. 1 shows a conventional design of a casting system useful for casting a stack of valve seat inserts.

FIG. 2 shows a new design of a casting system useful for casting a stack of parts such as a stack of valve seat insert casting blanks.

FIG. 3 shows a cross-sectional view of a casting apparatus including a casting header, cover mold, two mold plates and a bottom mold wherein each of the mold plates has a single mold cavity connected to an up-sprue by a circumferential gate.

FIG. 4 shows a cross-sectional view of a casting apparatus including a casting header, cover mold, two mold plates (each comprising a cope mold plate and a drag mold plate) and a bottom mold wherein each of the mold plates has a single mold cavity connected to an up-sprue by a circumferential gate.

FIG. 5 shows the appearance of a casting apparatus including a casting header, cover mold, two mold plates and a bottom mold wherein each of the mold plates has seven mold cavities connected to a seven up-sprues by seven circumferential gates.

FIG. 6 shows the appearance of a mold plate which includes cylindrical plugs fitted in cylindrical recesses to form ring-shaped mold cavities.

### DETAILED DESCRIPTION

Disclosed herein is an improved casting system useful for mass production of valve seat insert casting blanks made of high alloy compositions.

Unless otherwise indicated, all numbers expressing quantities, conditions, and the like in the instant disclosure and claims are to be understood as modified in all instances by the term “about.” The term “about” refers, for example, to numerical values covering a range of plus or minus 10% of the numerical value. The modifier “about” used in combination with a quantity is inclusive of the stated value.

In this specification and the claims that follow, singular forms such as “a”, “an”, and “the” include plural forms unless the content clearly dictates otherwise.

The terms “room temperature”, “ambient temperature”, and “ambient” refer, for example, to a temperature of from about 20° C. to about 25° C.

Valve seat inserts can be made from various alloy compositions which have been cast and machined. Large scale production of valve seat inserts is typically done by using stacked mold plates with multiple castings in each mold plate. With modern valve seat inserts, high alloy compositions are used to meet the high temperature, high stress, and harsh combustion environment conditions. Valve seat insert castings made of high-performance alloys for heavy-duty engine applications preferably have uniform and desired solidification substructures. However, solute distribution in a high alloy often involves solute element redistribution which affects the final solidification substructural formation and morphology. For example, with intermetallic strengthened cobalt-based alloys, it can be very difficult to achieve uniformly distributed solidification substructure such as between soft cobalt solid solution phases and intermetallic Laves phases. In some high alloys, eutectic reaction phases can form after formation of primary dendritic structures with the result being eutectic phases interdendritically distributed. Fine and uniform distribution of solidification structures including eutectic reaction phases is preferred from a product performance and component shaping related process (e.g., machining) consideration.

In order to improve yield of cast valve seat inserts, it is desirable to improve machining characteristics of the cast parts. Disclosed herein is a closed circuit liquid metal flow system for casting parts in a stacked mold plate apparatus which is designed to provide improved casting cavity-fill conditions resulting in a better cavity yield, finer casting surface appearance, and more consistent casting quality.

In an embodiment, liquid metal flow starts from the casting header of the stacked mold plate apparatus down through a down-sprue to a bottom distribution mold, then through a distribution runner to an up-sprue followed by filling casting molds layer by layer in the stacked mold plate apparatus. When all the casting molds are filled, the liquid metal can be directed by a channel in a cover mold which links the up-sprue to the down-sprue. Hence, a circuit of liquid metal flow can be achieved. Due to a high velocity liquid metal stream flowing during a liquid metal/alloy pouring in the down-sprue, air present in the up-sprue prior to up-sprue being filled by liquid metal can be sucked into the down-sprue region and released to the atmosphere through air gaps between liquid metal and walls of the down-sprue. Hence, low air pressure is created in the casting stacked mold plate system when a low-pressure cover mold is used. Low pressure casting forms a full loop of liquid metal flow contrasted to common static casting processes in which liquid metal flow always has an open end. For metal/alloy casting, an advantage of full loop liquid metal flow includes enhancement of cavity/casting yield capability compared to open end liquid metal flow.

For small size and high-volume casting manufacturing, such as valve seat insert (VSI) manufacture, a mass production method has been commonly applied for cost-effectiveness and sustainable manufacturing considerations.

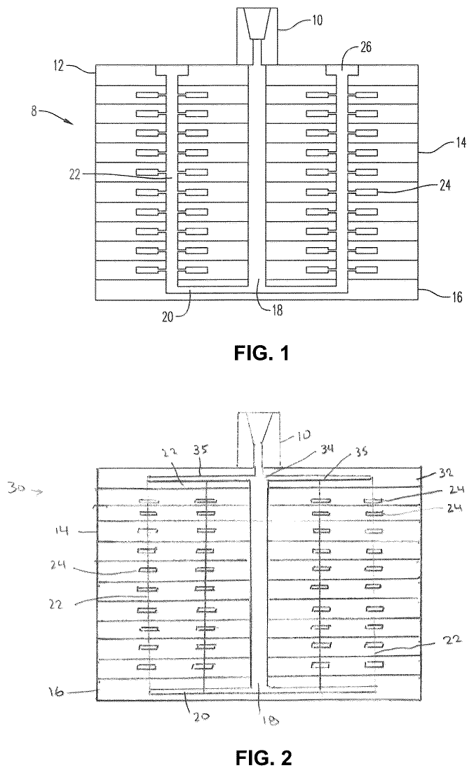

FIG. 1 shows a conventional design concept of such a mold stack 8 for VSI casting manufacture. In the design, a stack of molds includes a casting header 10, top mold 12, casting part mold plates 14, and liquid metal distribution mold plate (bottom mold) 16. During casting, liquid metal is poured into the casting header 10 which directs the liquid metal flow through a down-sprue 18 to one or more distribution runners 20 in the bottom mold 16. The distribution runner(s) 20 connects the down-sprue 18 to one or more up-sprues 22 having horizontal runners connected to a desired number of casting mold cavities 24 dependent upon mold and part sizes. Liquid metal distributed by the distribution runner(s) 20 flows up through the up-sprue(s) 22 primarily through a gravitation driving force. Subsequently, the liquid metal passes through horizontal runners and ingates to fill the casting cavities 24 layer by layer until all the casting cavities 24 are filled. The casting filling is commonly stopped when the liquid metal comes up through venting openings in alignment with upper-sprues and filled up into an even pressure channel 26 on the top mold 12.

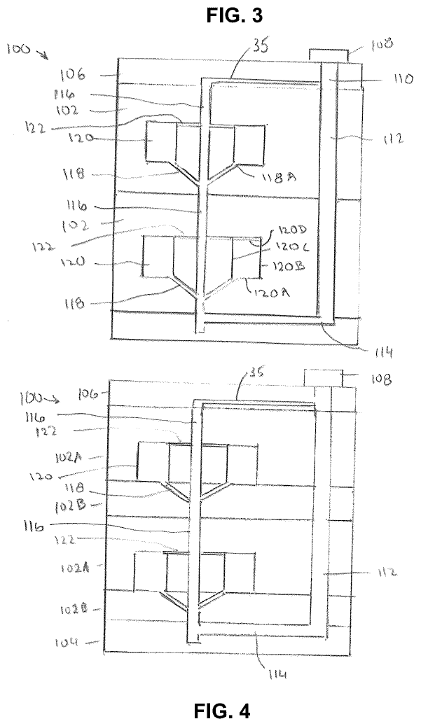

The new circumferential gating system design of a stack mold plate assembly 30 can be illustrated in FIG. 2. The design change compared to a conventional stacked mold plate assembly 8 is that the up-sprues 22 feed directly into the mold cavities 24 via circumferential gates 118 (not shown in FIG. 2 but illustrated in FIGS. 3 and 4) through which molten metal flows upwardly into the mold cavities 24 while molten metal rises in the up-sprues 22.

The stack mold plate assembly 30 can optionally include a low-pressure cover mold 32 (as described in commonly-owned co-pending U.S. patent application Ser. No. 18/403,120 filed Jan. 3, 2024, the subject matter of which is hereby incorporated by reference) which replaces the even pressure channel top mold 12 shown in FIG. 1. The low-pressure cover mold 32 can provide a circuit flow system in which liquid metal in up-sprues 22 is not directly exposed to atmospheric pressure. As a result, the low-pressure cover mold can provide consistent liquid metal flow, a lower sensitivity to the occurrence of trapped gas in the molded parts, and/or provide the cast parts with a fine casting surface appearance.

FIG. 3 shows an embodiment wherein a stack mold plate assembly 100 includes mold plates 102 incorporating a circumferential gating design. As shown, the mold plate stack assembly 100 includes two mold plates 102, a bottom mold 104, a top mold 106, a casting header 108, a down-sprue 112, a distribution runner 114, an up-sprue 116, a circumferential gate 118 and two mold cavities 120. If desired, a gas release passage 122 can be provided connecting the top of each mold cavity 120 with the up-sprue 116. While only two mold plates 102 and two mold cavities 120 are shown, the stack mold plate assembly 100 can have any desired number of mold plates having any desired number of mold cavities in each plate.

The circumferential gate 118 is a divergent annular flow path having an exit opening 118A at the end of spaced apart conical walls 118B, 118C arranged with a small diameter end located at the up-sprue 116 and a larger diameter end that opens circumferentially into the mold cavity 120. The circumferential gate 118 provides advantages over a conventional gating system which includes runners to connect the up-sprue to the mold cavities. For example, the runner-free gating design using the circumferential gate 118 can increase the casting yield (casting mass over total metal applied to fill the casting stack) compared to a runner-based gating design.

The mold plates 102 can be made by any suitable technique. In an embodiment, a mold plate 102 is made by 3D printing powders (such as green sand) in layers wherein areas corresponding to passageways (e.g. the down-sprue 112, up-sprue 116, circumferential gates 118, mold cavities 120 and optional gas release passages 122) are printed unbound powder (such as green sand) and the remaining areas are binder covered sand layers. After enough layers are printed to form the mold plate, the unbound powder (sand) can be removed from the mold plate leaving open passageways corresponding to the down-sprue 112, up-sprue 116, circumferential gates 118, mold cavities 120 and optional gas release passageways 122. The mold plates 120 can be assembled to form a mold plate stack wherein the passageways corresponding to the down-sprue and up-sprue are aligned. Details of a 3D printing process using bound and unbound powder can be found in U.S. Pat. No. 7,807,077, the disclosure of which is hereby incorporated by reference.

In another method, a mold plate 102 can be made by repeated steps of depositing a layer of powder and selectively printing a binder solution into the layer in a first pattern representative of a layer of the final mold plate, printing a channel support agent in a pattern representative of internal channels (down-sprue 112, up-sprue 116, gates 118, mold cavities 120 and optional gas release passageways 122) in the final mold plate. While openings corresponding to the down-sprue 112, up-sprue 116 and mold cavities 120 preferably extend axially with uniform diameters, each of the circumferential gates 118 is a divergent annular flow path that extends radially outward and upward from the up-sprue 116 to an area adjacent the lower end of the mold cavity 120.

After enough layers are formed into a body corresponding to the mold plate, the body can heated to remove the binder and generate a green body, the green body ca be heated above a second temperature to sinter the powder and remove the channel support agent thereby forming the mold plate with internal passageways corresponding to the down-sprue, circumferential gates, mold cavities and optional gas release passageways. The mold stack 100 is assembled by stacking the mold plates 102 to align the down-sprue 112 and up-sprue 116 passageways. Details of a 3D printing process using a channel support agent can be found in U.S. Pat. No. 10,343,214, the disclosure of which is hereby incorporated by reference.

The optional cover mold 32 can be manufactured using conventional 3D printing compositions. See, for example, U.S. Patent Publication Nos. 2018/0222082 and 2021/0162633 assigned to Voxeljet AG. As shown in FIG. 2, the cover mold 32 has a central opening 34 corresponding to the down-sprue 18 and internal passages 35. The internal passages 35 can comprise horizontal sections extending radially outward from the central opening 34 and vertical sections in the form of vertically extending recesses in fluid communication with outer ends of the horizontal sections and configured to be in alignment with the up-sprues 22 in the mold plates 14.

FIG. 4 shows an embodiment wherein a stack mold plate assembly 100 includes mold plates 102A, 102B incorporating a circumferential gating design. As shown, the mold plate stack assembly 100 includes mold plates wherein a cope mold plate 102A overlies a drag mold plate 102B, a bottom mold 104, a top mold 106, a casting header 108, a down-sprue 112, a distribution runner 114, an up-sprue 116, two circumferential gates 118 and two mold cavities 120. If desired, a gas release passage 122 can be provided connecting the top of each mold cavity 120 with the up-sprue 116. While only four mold plates 102A, 102B and two mold cavities 120 are shown, the stack mold plate assembly 100 can have any desired number of mold plates having any desired number of mold cavities in each plate. Mold plates 102A, 102B can be made by conventional sand molding techniques or using 3D printing as described above.

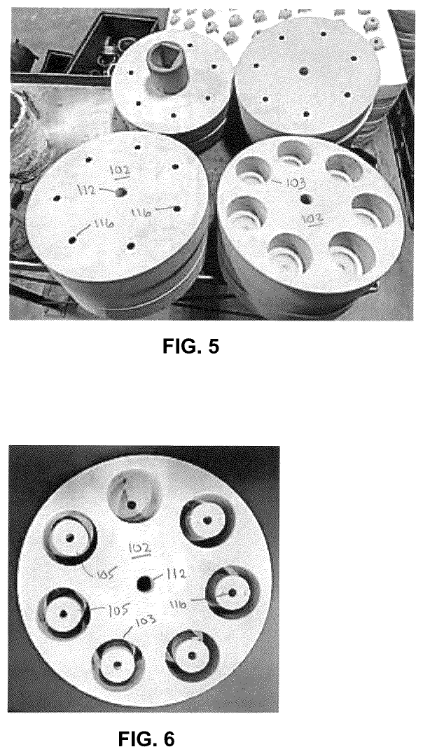

The mold stack 100 can include various arrangements of sprues, runners/gates and mold cavities. Depending on the size of the valve seat inserts, each mold plate 102 can have a single up-sprue 116 or multiple up-sprues 116, each connected to a mold cavity 120 by a circumferential gate 118. In an example, a mold plate 102 may have one, two, three, four, five, six, seven (as shown in FIG. 5), or more up-sprues 22 and an equal number of mold cavities 120 in communication with each up-sprue 116 via circumferential gates 118. The mold cavities 120 are preferably ring-shaped cavities formed by a space between a ring-shaped bottom wall 120A, a cylindrical outer wall 120B, a cylindrical inner wall 120C, and a ring-shaped upper wall 120D.

As shown in FIG. 5, a single mold plate 102 can include seven up-sprues 116 which are spaced circumferentially around a central down-sprue 112. The mold plate 102 can have seven circular recesses 103 extending into an upper surface and center plugs (not shown) can be inserted into the recesses 103 to form the ring-shaped mold cavities 120. FIG. 6 shows a mold plate 102 with center plugs 105 inserted in six of the recesses 103 and one recess 103 with the center plug 105 removed. Each center plug 105 has a conical bottom wall which is arc-shaped (slightly rounded) and faces a conical wall in the mold plate 102 to thereby define the circumferential gate 118. With this arrangement, the up-sprues 116 extend through the mold plate 102 and center plugs 103 and align with up-sprues 116 in an overlying mold plate 102. Accordingly, the mold plate 102 can include a cylindrical recess 103 having an outer cylindrical wall defining an outer wall of the mold cavity 120 and a center plug 105 located in the cylindrical recess 103 with an outer cylindrical surface of the center plug 105 forming an inner wall of the mold cavity 120, the center plug having a central opening aligned with the up-sprue 116 and a conical bottom surface in the mold plate 102 defining the circumferential gate 118.

In order to provide a more uniform temperature distribution during solidification of molten metal in the mold cavities 24, the mold plate 14 can include outer and inner thermal barriers (not shown) as described in commonly-owned U.S. Pat. No. 10,421,116. The outer thermal barrier can be annular channels extending into an upper surface of the mold plate such that the annular channels form outer and inner thermal barriers via air gaps which minimize heat transfer in directions towards the down-sprue and exterior of the mold plate. The annular channels preferably have a depth about equal to the vertical height of the mold cavity and a width of about 0.005 to 0.3 inch. For instance, the annular channels can have a width of about 1/16 to ¼ inch. With or without the advantage of the thermal barrier which provides an even and low temperature gradient along the radial direction in the mold plates, the optional cover mold 32 with a fluid passage 35 connecting the up-sprues 22/116 to the down-sprue 18/112 can contain heat in the stack during metals/alloys pouring hence a low temperature gradient distribution especially along the casting stack vertical orientation can be obtained and thereby achieve a desired solidification condition of the molten metals/alloys and better casting quality.

As noted above, one or more channels in the cover mold form a fluid passage connecting one or more up-sprues to the down-sprue. Due to the 3D printing technique, the one or more channels can be located entirely inside the cover mold rather than extend into the lower surface of the cover mold. With such arrangement, the air originally in the mold cavities and up-sprue will be released through the internal channel(s) of the cover plate to the down-sprue. Because the high flow rate of liquid metal during pouring down through down-sprue, localized low pressure can be created which draws the air from the up-sprue(s) toward down-sprue area.

The cover mold and mold plates can be made of a sand/binder composition. For 3D printing of the cover mold, various sand compositions can be used which include silicon oxide sand, river sand or lake sand.

The mold plates can have any desired number of mold cavities and up-sprues. For example, each mold plate can have 1, 2, 3, 4, 5, 6, 7, 8, 9 or 10 up-sprues depending on the OD of the mold plates and size of the valve seat insert casting blanks.

In the process of casting parts, as the molten metal rises from the bottom to fill the mold cavities of each mold plate, the molten metal is preferably not under any pressure except gravitational force. For static casting, the driving force is gravitational force only. For conventional mold stack designs, the force needs minus atmospheric pressure from up-sprue opening(s). However, the atmospheric pressure can be substantially reduced with low pressure cover plate concept.

During a casting operation, air is forced out of the mold cavities by the rising molten metal as the mold fill occurs layer by layer. Any remaining air in the up-sprues is forced into the down-sprue as the liquid metal fills the channels in the cover plate as the down-sprue region becomes a low pressure region when using the low pressure cover plate. With the low pressure cover plate concept, escaping air is not exposed to atmospheric air until it leaves the casting header. This is possible because the liquid metal stream during pouring will not occupy the entire space of up-sprue, thus allowing escaping air to pass upwardly through the down-sprue.

The new stack mold apparatus 100 can be used for mass production of cast metal parts such as valve seat insert casting blanks wherein circular mold plates 102 made of sand are stacked vertically between the bottom mold 104 and a cover mold 106. Each mold plate 102 can be made integrally (FIG. 3) by a 3-D printing technique or each mold plate 102 can have a cope and drag arrangement with an upper cope plate 102A and lower drag plate 102B stacked together to form a single mold plate (FIG. 4).

A casting header 108 is located at any location on the cover mold 106 such as at the center of the cover mold 106 with an opening such as a central opening 110 aligned vertically with a down-sprue such as central down-sprue 112 extending through the cover mold 106. The down-sprue 112 extends downwardly through each mold plate 102 and communicates with one or more horizontal distribution runners 114 below the lowest mold plate 102. The distribution runners 114 communicate with one or more up-sprues 116 extending upwardly through the mold plates 102. Each up-sprue 116 communicates with one or more circumferential gates 118 which communicate with one or more mold cavities 120 in each mold plate 102.

In an embodiment, the mold cavities 120 are designed to form valve seat inserts and each mold cavity 120 is annular in shape with a ring-shaped bottom wall 120A, a cylindrical outer wall 120B having an outer diameter, a cylindrical inner wall 120C having an inner diameter and a ring-shaped upper wall 120D. The up-sprues 116 are located inwardly of the inner wall 120C of the mold cavity 120 and the circumferential gate 118 has an annular exit opening 118A located at the bottom of the mold cavity 120. For example, the annular exit opening 118A of the circumferential gate 118 can be located in the bottom wall 120A of the mold cavity 120 or on the inner wall 120C where the inner wall 120C adjoins the bottom wall 120A of the mold cavity 120. In an embodiment, the annular gate 118 is formed by a space between an inner conical wall 118B and an outer conical wall 118C.

In an embodiment, tops of the up-sprues 116 can communicate with internal fluid passages in the cover mold 106 which communicate with the down sprue 112. When molten metal is poured into the casting header 110, the liquid metal flows through the down-sprue 112, the horizontal runners 114, the up-sprues 116, the circumferential gates 118 into the mold cavities 120 and pouring of molten metal is stopped when the liquid metal fills the internal passages in the cover mold 106. If desired, each mold plate can include a gas release passage 122 in fluid communication with an upper end of the mold cavity 120 and the up-sprue 116, as shown in FIGS. 3 and 4. By incorporating the gas passage 122, during mold cavity filling, gas can escape from a mold cavity 120 to an upper unfilled part of the up-sprue 116 as molten metal flows upward into each mold cavity 120. The gas passage 122 can be at least one radially extending channel in an upper surface of a mold plate 102 or in a lower surface of an overlying mold plate 102. Alternatively, the gas passage 122 can be annular recess extending into an upper surface of a mold plate 102 containing the mold cavity or lower surface of an overlying mold plate 102.

The circumferential gate 118 can be in fluid communication with each mold cavity 120 via an annular opening 118A extending into the bottom wall 120A and/or inner wall 120C of the mold cavity 120. Preferably, the circumferential gate 118 is cone-shaped such that molten metal will flow radially outward and upward from a portion of the up-sprue 116 below the mold cavity whereby as the mold cavity 120 fills with molten metal at substantially the same velocity as the molten metal rises in the up-sprue 116. Alternatively, the circumferential gate 118 can be disc-shaped in which case molten metal will flow radially outward from the up-sprue 116 and into the mold cavity 120 and fill the mold cavity at substantially the same velocity as the molten metal rises in the up-sprue 118. Consequently, the mold cavities can be filled with molten metal flowing axially upward more uniformly than in the case of side gating of the mold cavities.

Depending on the size of the parts to be cast, each mold plate 102 can have an appropriate number of up-sprues 116 each of which is in fluid communication with a single mold cavity in the mold plate 102. By stacking the mold plates 102, the number of parts cast in a single pouring operation can be SxP where “S” is the number of up-sprues and “P” is the number of mold plates. For example, with 10 mold plates 102 having 5 up-sprues 116 in each, 50 parts can be cast. With 3-D printing of the mold plates, the diameter of each mold plate 102 can range from 11 to 25 inches. Depending on the size of the mold cavities 120, the number of mold cavities 120 in each mold plate 102 can range from 3 to 33. In addition, each mold plate 102 can have mold cavities 120 which are identical in size or variable in size. For example, a mold plate 102 can have mold cavities 120 of a first uniform size and an adjacent mold plate can have mold cavities 120 of a larger or smaller uniform size. Alternatively, at least one mold plate 102 of the stack can have mold cavities 120 with different sizes such as mold cavities 120 which form two or more different sized valve seat insert casting blanks. A mold plate 102 suitable for casting large size valve seat inserts can have 1, 2, 3, 4, 5, 6, 7, 8 or 9 mold cavities 120, each fed by a single up-sprue 116 and circumferential gate 118. Because the circumferential gate 118 feeds molten metal into the mold cavity 120 through an annular opening at the bottom of the mold cavity 120, the molten metal can flow evenly into the mold cavity 120 and fill the mold cavity 120 as molten metal in the up-sprue 116 rises at substantially the same velocity and level as the molten metal in the mold cavity 120.

The cast metal parts such as valve seat insert casting blanks can be made by pouring molten metal into a gating system of a mold plate stack wherein mold plates are located between top (cover) and bottom molds. The mold plates are preferably made of conventional green shell sand for valve seat insert (VSI) casting applications and are designed such that during solidification of the molten metal in the mold cavities, the binder in the sand is volatilized and thin sand walls forming the inner surfaces of the valve seat inserts collapse as the valve seat inserts contract due to shrinkage upon solidification of the molten metal.

In a preferred casting system for mass production of valve seat inserts, mold plates made of sand and having a diameter of about 14 inches can have a central 1 inch diameter down-sprue, horizontal bottom distribution runners feeding an equal number of up-sprues having diameters of about ½ to ¾ inch, and circumferential gates. However, 3D printing allows the mold plates to have larger sizes and thus increase production output of the valve seat insert casting blanks.

It will be appreciated by those skilled in the art that the casting method and apparatus described herein can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of casting metal parts, comprising:
pouring molten metal into a gating system of a mold plate stack having mold cavities wherein mold plates are located between a cover mold and a bottom mold, the gating system including a casting header, down-sprue passing though the mold plates, at least one distribution runner in fluid communication with the down-sprue, at least one up-sprue in the mold plates, and at least one circumferential gate in each mold plate with the circumferential gate in fluid communication with a lower portion of a single mold cavity configured to form a metal part, the gating system optionally including at least one gas release passage in fluid communication with the up-sprue and the mold cavity;
filling the mold cavities with the molten metal such that molten metal passes into the down-sprue, the distribution runner and into the up-sprue in a lowermost mold plate, then through the circumferential gate and into the mold cavity, rises in the mold cavity and in the up-sprue at substantially the same velocity and at substantially the same height until the molten metal fills the mold cavity, then into the up-sprue of an overlying mold plate and repeats the mold cavity filling process of the lowermost mold plate until all of the mold cavities are filled with the molten metal;
and solidifying the molten metal to form cast metal parts interconnected by solidified metal in the down-sprue, the distribution runner, the up-sprue, and the circumferential gates.

2. The method of claim 1, wherein at least one of the mold plates is a 3D printed sand composition having a gas release passage, the method including release of gas from the mold cavity via the gas release passage into an open portion of the up-sprue during filling of the mold cavity with molten metal.

3. The method of claim 1, wherein each of the mold plates has a plurality of up-sprues and mold cavities, the bottom mold has a plurality of distribution runners in fluid communication with the down-sprue and the up-sprues, and the mold stack includes gas release passages, the method including release of gas from the mold cavities via the gas release passages into open portions of the up-sprues during filling of the mold cavities with molten metal, thereby enhancing laminar molten metal flow and minimizing turbulence of molten metal during filling of the mold cavities.

4. The method of claim 1, wherein the mold cavity is ring-shaped and the circumferential gate is formed by spaced apart inner and outer conical walls which form a divergent annular flow path, the method including filling the divergent annular flow path with molten metal such that the molten metal flows evenly into the bottom of the ring-shaped mold cavity.

5. The method of claim 4, wherein the ring-shaped mold cavity has a bottom wall, a top wall, a circumferential outer wall and a circumferential inner wall, the method including flowing molten metal through the divergent annular flow path into a circumferential opening in the bottom wall or inner wall of the ring-shaped mold cavity.

6. The method of claim 5, wherein each of the mold plates is a circular sand mold plate having a central opening corresponding to the down-sprue extending vertically between upper and lower surfaces of the mold plate, at least two circumferentially spaced openings corresponding to up-sprues extending vertically between the upper and lower surfaces of the mold plate, at least two ring-shaped mold cavities surrounding the up-sprues, at least two circumferential gates extending from the up-sprues to bottoms of the two ring-shaped mold cavities, the method including solidification of the molten metal in the ring-shaped mold cavities and forming a mold stack of parts comprising valve seat insert casting blanks.

7. The method of claim 6, wherein each of the mold plates is a circular sand mold plate having a central opening corresponding to the down-sprue extending vertically between upper and lower surfaces of the mold plate, at least four circumferentially spaced openings corresponding to the up-sprues extending vertically between the upper and lower surfaces of the mold plate, at least four ring-shaped mold cavities surrounding the up-sprues, at least four circumferential gates connecting the up-sprues to the ring-shaped mold cavities, the method including solidification of the molten metal in the ring-shaped mold cavities and forming a mold stack of parts comprising valve seat insert casting blanks.

8. The method of claim 6, wherein each of the mold plates is a circular sand mold plate having a central opening corresponding to the down-sprue extending vertically between upper and lower surfaces of the mold plate, at least five circumferentially spaced openings corresponding to the up-sprues extending vertically between the upper and lower surfaces of the mold plate, at least five ring-shaped mold cavities surrounding the up-sprues, at least five circumferential gates extending between the up-sprues and the ring-shaped cavities, the method including solidification of the molten metal in the ring-shaped mold cavities and forming a mold stack of parts comprising valve seat insert casting blanks.

9. The method of claim 1, wherein the molten metal is a wear and corrosion resistant iron-base alloy, nickel-base alloy, cobalt-base alloy, or intermetallic-base alloy, the method further comprising maintaining a substantially uniform temperature distribution of the molten metal in a vertical direction during solidification of the molten metal in the mold cavities.

10. The method of claim 3, wherein the cover mold includes a fluid passage extending from the upper end of the up-sprue to the down-sprue, the method further comprising solidifying the molten metal after the molten metal fills the fluid passage, the cover mold allowing escape of trapped air into the down-sprue and providing sufficient thermal insulation in a vertical direction to improve surface quality of the cast parts.

11. A mold plate of a casting apparatus comprising a casting header, a cover mold, a bottom mold, and stack of mold plates having mold cavities, and a gating system including a casting header, down-sprue passing though the mold plates, at least one distribution runner in fluid communication with the down-sprue, at least one up-sprue in the mold plates, and at least one circumferential gate in each mold plate in fluid communication with a single mold cavity configured to form a metal part, mold plate comprising:
a down-sprue opening extending between an upper surface and lower surface of the mold plate;
an up-sprue opening extending between the upper surface and the lower surface of the mold plate;
a mold cavity surrounding the up-sprue; and
a circumferential gate connecting the up-sprue to a bottom of the mold cavity.

12. The mold plate of claim 11, wherein the mold plate is a 3D printed sand composition.

13. The mold plate of claim 11, wherein the mold plate has a plurality of up-sprue openings and mold cavities, each of the up-sprues connected to a respective one of the mold cavities by a circumferential gate.

14. The mold plate of claim 11, wherein the circumferential gate comprises a divergent annular flow path defined by a space between inner and outer conical walls.

15. The mold plate of claim 14, wherein the mold cavity is a ring-shaped mold cavity with a bottom wall, top wall, outer cylindrical wall and inner cylindrical wall, the divergent annular flow path having a smaller diameter inlet end in fluid communication with the up-sprue opening and a larger diameter outlet end in fluid communication with the ring-shaped mold cavity via a circumferential opening in the bottom wall or inner wall of the ring-shaped mold cavity.

16. The mold plate of claim 11, wherein a gas release passage extends from an upper portion of the mold cavity to the up-sprue opening.

17. The mold plate of claim 11, wherein the mold cavity is located entirely within the mold plate.

18. The mold plate of claim 11, wherein the mold plate comprises an upper cope mold plate and lower drag mold plate with the mold cavity extending into a lower surface of the cope mold plate and the circumferential gate located in the drag mold plate, or the mold plate including a cylindrical recess having an outer cylindrical wall defining an outer wall of the mold cavity and a center plug located in the cylindrical recess with an outer cylindrical surface of the center plug forming an inner wall of the mold cavity, the center plug having a central opening aligned with the up-sprue and a conical bottom surface defining the circumferential gate.

19. A casting apparatus comprising a casting header, a cover mold, a bottom mold, and the mold plate of claim 11, wherein a gating system of the casting apparatus includes the casting header, the down-sprue passing though the mold plate, a distribution runner in the bottom mold in fluid communication with the down-sprue and the up-sprue in the mold plate, and the circumferential gate in fluid communication with the mold cavity.

20. The casting apparatus of claim 19, wherein the mold plate is in a stack of identical or non-identical mold plates, each of the mold plates including a plurality of up-sprues, mold cavities and circumferential gates, the casting apparatus further including gas release passages between the mold cavities and the up-sprues so that air in the mold cavities can escape to the up-sprues during filling of the mold cavities with molten metal.
